(19) United States
(12) Patent Application Publication
(10) Pub. No.: US 2007/0296376 A1
(43) Pub. Date: Dec. 27, 2007

(54) Self-Powered Electric Charger

(75) Inventors: Didier Marquet, Malakoff (FR); Michel Vernet, Meylan (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/667,733

(22) PCT Filed: Oct. 26, 2005
(86) PCT No.: PCT/FR05/02684

§ 371 Date: May 15, 2007

(30) Foreign Application Priority Data
Nov. 15, 2004 (FR) 0412088

(51) Int. Cl. H02J 7/00

(52) U.S. Cl. 320/101; 320/117; 320/123

(57) ABSTRACT

The invention relates to an electric charger (1) comprising: an electrical energy storage module (3) having a connection interface (31) to an external battery (41, 42); an electrical generator (2) the energy supply for which can be controlled, in order to supply electrical energy to the storage module (3), at an operating point; and generator (2) control means (5) which are designed to adapt the operating point of the generator (2) when it is supplying electrical energy to the storage module (3) in accordance with information (530) relating to the state of the storage module (3) and information (520) relating to the state of the generator.

The present invention relates to an electric charging device for rechargeable equipment. More specifically, the invention relates to a battery charger which has a primary energy source which comprises at least one electrical generator and is intended for portable or mobile equipment.

Current progress relates to fuel cells, fed by a fuel reserve, for example in the form of liquid methanol or gaseous hydrogen, whereby systems which can feed, for example, portable terminals, can be envisaged.

A self-powered charger operating with electrical cells is known for recharging mobile telephones. The device comprises a cell and does not therefore require connection to a mains socket. It is equipped with an output and the connection means necessary in order to supply the telephone battery with the energy required to recharge it.

However, cells with a high energy density cannot supply a high average energy compared with the average energy supplied by a fast mains charger of equivalent cost, volume and mass. Moreover, given that the voltages of the cells are generally low and are often insufficient to be used alone, it is necessary to connect them in series or to increase their voltage electronically in order to obtain a sufficient voltage. However, the usable intensity, which is already low on average for a cell, is furthermore limited by the weakest cell in the series, or by electronic losses, further reducing the overall available energy density. Moreover, the start-up time of the cells, including their rise in temperature, may be quite long, and the operating conditions are less well controlled than those of the batteries. The charging of a battery using a device of this type is therefore very slow, particularly in the case of fuel cells.

One object of the present invention is to overcome these disadvantages by proposing an electric charger which has a primary energy source which enables fast charging of rechargeable devices.

The invention therefore proposes an electric charger comprising an electrical energy storage module having a connection interface to an external battery, an electrical generator supplied with energy in a controllable manner in order to supply electrical energy to the storage module, at an operating point, control means of the generator designed to adapt the operating point of said generator when it supplies electrical energy to the storage module, according to information relating to the state of the storage module and information relating to the state of the generator.

The electrical generator slowly charges the electrical storage module. The electrical storage module in turn enables fast discharge, thus supplying the battery of the device connected to the output with the power necessary for fast charging. Then, if no device to be recharged is connected, or if the charge level of the electrical storage module falls below a predetermined threshold, the control means restart the generator. The operating point of the generator, defined by its output voltage and by the intensity of its output current, is adapted according to the state of the storage module and the state of the generator. Thus, the input current and voltage of the storage module are controlled in such a way as to reduce losses while the energy storage module is charging, but also to avoid damage to this module, for example through overcharging. Information is supplied, for example, relating to the charge remaining in the energy storage module, to its temperature or its pressure. Similarly, this operating point may also be controlled in order to obtain the maximum output of the electrical generator. The information relating to the operating point of the generator supplied to the control means may also include its temperature, or the amount of energy still available.

Thus, the output of the electrical generator can be improved as its operation can be adapted in order to obtain an optimum operating point. Moreover, wear and deterioration of the electrical energy storage module can be avoided.

The electrical generator may, for example, be a thermoelectric or thermodynamic generator, or an electrochemical cell such as a fuel cell.

The electrical energy storage module may be an array of electrical storage elements, such as, for example, a battery or a supercap, or a combination of batteries and supercaps.

Moreover, various embodiments of the invention may possibly comprise one and/or the other of the following arrangements:
the generator is an electrochemical generator;
the generator control means are designed to control a chemical reaction in the generator, according to information relating to the state of the storage module;
the storage module connection interface comprises a matching circuit to adapt output parameters of the storage module to charging parameters of the battery;
the information relating to the state of the storage module includes its charge, its temperature, its pressure, its voltage or its intensity, at the input or output;
the storage module comprises a plurality of storage elements and switching means to connect the storage elements in parallel while charging and in series while discharging;
the electric charger furthermore comprises means to charge the storage module from an external energy source;
the external source comprises a mains connection cable or a USB cable;
at least one from the electrical generator, the storage module and the external battery comprises an identification device adapted to supply data to the control circuit, said control circuit being configured to adapt its control on the basis of said data;
the electrochemical generator comprises a fuel cell.

Other characteristics and advantages of the present invention will be explained in the description below with reference to non-limiting exemplary embodiments and to the attached drawings, in which:

FIG. 1 is a summary diagram of a charger according to the invention,

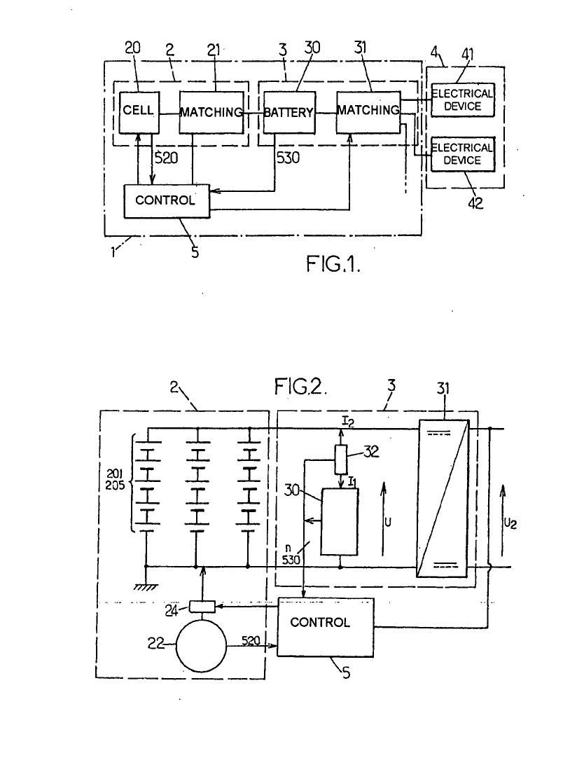

FIG. 2 shows a first exemplary embodiment using an array of fuel cells and NiMH batteries,

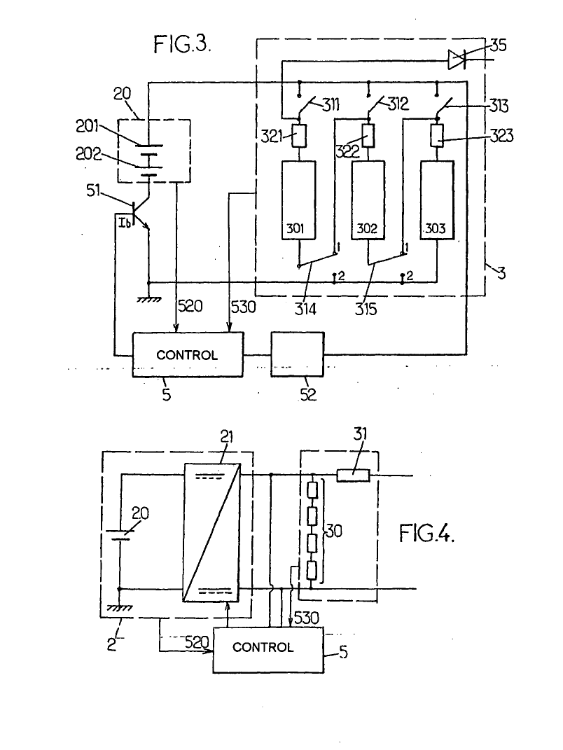

FIG. 3 shows an exemplary embodiment implementing Zinc-Air cells and NiMH batteries disposed in parallel while charging, then connected in series while discharging,

FIG. 4 shows an exemplary embodiment implementing a Zinc-Air cell comprising a voltage booster between the cells and the buffer battery.

In the different figures, the same references have been retained to designate identical or similar elements.

FIG. 1 shows an electric charger 1 comprising an electrochemical generator 2 which transfers its power to an electrical energy storage module 3. An array of electrical devices 4, which may comprise a plurality of electrical devices 41, 42, etc., is connected to the output of the charger 1.

The electrochemical generator 2 may comprise, for example, a cell 20. Matching means 21 enable matching of the operating point of the cell 20 to the input parameters of the electrical energy storage module 3.

The electrical energy storage module 3 comprises an accumulator which consists of a battery 30 in the example shown. Said battery has a relatively low energy density, but a high energy density compared with the cell 20 of the electrochemical generator 2. A matching circuit 31 enables matching of the output parameters of the battery 30 to the input parameters of the electrical devices 41, 42, etc.

Information 530 relating to the state of the battery 30 and information 520 relating to the state of the cell 20 is transmitted to a control circuit 5 which controls the operation of the cell 20 of the electrochemical generator 2 in order to charge the battery 30. The control circuit 5 also controls the matching circuit 21 of the electrochemical generator 2 in such a way as to feed the storage module 3 in a correct manner, while positioning itself close to an optimum operating point of the electrochemical generator 2. The control circuit 5 also controls the matching circuit 31 of the buffer circuit 3 according to the information 530 relating to the state of the battery. This information 520 and 530 comprises, for example, the pressure, the temperature of the cell 20 and of the battery 30, the voltage at their terminals, the intensity of the output current of the cell 20 or the intensity of the current entering the electrical energy storage module, or the charge of the battery 30, the amount of energy available in the cell 20, or at least an estimation of these parameters.

In the embodiment shown in FIG. 2, the electrochemical generator 2 may comprise the connection in series or in parallel of a plurality of cell elements, more specifically fuel cells 201 to 205, and, for example, a reservoir of methanol 22 supplying fuel to the fuel cell elements 201 to 205 via a micropump 24, the supply of oxygen being implemented using an air inlet (not shown).

The electrical energy storage module 3 shown in FIG. 2 comprises a Nickel battery 30, such as the NiCd or NiMH batteries, a resistor 32, connected in series with the battery and enabling measurement of the input current I1 and output current I2 of the battery 30, and a matching circuit 31. The matching circuit 31 delivers a direct voltage of 5 V at the output of the charger 1, said output being connected to a device whose battery is to be recharged.

A control circuit 5 controls the micropump 24 of the reservoir 22 of the fuel cell 20 according to the voltage measured at the terminals of the resistor 32, proportional to the current I1 of the battery 30, and according to the voltage at the terminals of the battery 30.

If the battery 30 is discharged, the voltage at its terminals U is low and it cannot deliver a high intensity. Thus, if the voltage U is less than 1.35 V, and if the intensity of the output current I2 of the battery is less than 10 mA, the control circuit 5 activates the micropump 24 of the reservoir of methanol 22 of the fuel cell 20 in order to recharge the battery 30. If the battery is charged, the voltage at its terminals U is high, but only permits a low input recharge current intensity. For example, if the voltage U is greater than 1.43 V, and if the intensity of the input current I1 is less than 25 mA, the control circuit 5 stops the micropump 24, similarly stopping the production of energy by the fuel cell 20.

When the battery 30 is charging, the control circuit 5 can regulate the consumption of methanol by means of the micropump 24 in order to reach an optimum operating point of the fuel cell 20. The micropump 24 can thus act, for example, on the pressure and the flow of fuel. In similar fashion, the control could be effected by regulating the air inlet of the cell 20 (not shown), or the flow of water formed during the reaction, by acting on the pumps or the fans at the input or output. In this latter case, the information 520 originating from the cell 20 could comprise the mass of the fuel cell or the water vapor output pressure.

For an optimum operating point, an operating point of the fuel cell can be used where efficiency is maximum, or an operating point enabling charging of the storage module in the fastest or most efficient manner. In fact, the amount of energy contained in a battery is a function of the charging intensity. The lower this intensity, the greater the amount of energy that the battery can contain, but the longer the charging time.

This embodiment offers the advantage that it provides a charger which operates with fuel cells but which can nevertheless provide fast charging of the battery of the device connected at the output. Moreover, thanks to the voltage booster 31, it supplies a voltage U₂ which is sufficiently high to recharge Lithium batteries, which are currently used in portable devices.

A different embodiment, shown in FIG. 3, uses a Zinc-Air cell 20 comprising two cell elements 201 and 202 connected in series. The storage module comprises three Nickel batteries 301, 302 and 303 connected in series, each with a resistor 321, 322 and 323. Switches 311, 312, 313, 314 and 315 are disposed in such a way that they can connect the batteries 301, 302 and 303 in series or in parallel. Moreover, a diode 35 is connected between the output and the batteries 301, 302, 303, in such a way as to prevent any return of current into the batteries 301, 302, 303.

The control circuit 5, fed by means of a voltage booster circuit 52, controls a transistor 51, such as a bipolar transistor, in order to disconnect the cell 20 when the batteries 301, 302, 303 are charged.

When the batteries 301, 302, 303 are charging, the switches 311, 312, 313, 314, 315 are actuated, for example, in such a way that the batteries 301, 302, 303 are connected in parallel. Thus, the cell 20 transfers a low intensity to each battery 301, 302 and 303. The current may be regulated by means of the transistor 51, acting on the base current Ib of the transistor.

Conversely, when the batteries 301, 302, 303 are discharging, the switches 311, 312, 313, 314, 315 are actuated in such a way that the batteries 301, 302, 303 are connected in series. Thus, the output voltage is higher during discharge.

This embodiment offers the advantage that it provides a high output voltage without requiring a voltage booster circuit at the output.

FIG. 4 shows a fourth embodiment, in which a Zinc-Air cell 20 is used as an electrochemical generator. The output voltage of the cell is boosted by a voltage adapter circuit 21. By way of example, the voltage of 0.9 to 1.2 V at the output of the cell is boosted to 5.7 V by the circuit 21.

The energy storage module 3 comprises the series connection of four batteries 30 and a resistor 31, enabling limitation of the output current feeding the devices to be recharged (not shown).

A control circuit 5, fed by the batteries 30, controls the matching circuit in such a way that, if the voltage at the terminals of the batteries 30 is lower than, for example, 5.4 V, the matching circuit 21 allows the power of the cell 20 to pass to the batteries 30. Conversely, if the batteries 30 are charged, the voltage at their terminals is greater than 5.7 V and the matching circuit 21 stops the transfer of power from the cell 20 to the batteries 30.

According to a different aspect of the invention, the electric charger also comprises an input which can be connected to an external source such as a USB port or a mains voltage. This external source is used as a secondary generator, if, for example, the electrochemical generator can no longer supply energy. The external source is connected to the electrical energy storage module via a matching circuit, regulating the voltage and limiting the current, and a non-return diode.

Gauges showing the storage state of the batteries and of the electrical generator are used in one embodiment.

According to one embodiment, the control circuit of the generator and possibly of the energy storage module is electronic and possibly comprises a microcontroller or a microprocessor. Thus, it may be possible to program the control circuit according to the elements used with the charger, i.e. the electrical generator, the storage module, or the devices to be recharged. This programming may be carried out at the command of the user, for example by a radio command, or by way of a connection cable, or by replacing the memory containing the program.

The control circuit possibly identifies the types of the generator, the storage module or the devices to be recharged in order to adapt operation according to these devices. The identification may be automatic, for example, if these elements comprise radio tags or chips, attached to the latter and capable of communicating, for example, via radio waves or through contact with the control circuit.

According to a different embodiment, the electrical generator is a thermodynamic generator, in which the heat source is ambient air and the cold source is a reserve of liquid air.

1. An electric charger (1) comprising:
an electrical energy storage module (3) having a connection interface (31) to an external battery (41, 42),
an electrical generator (2) supplied with energy in a controllable manner in order to supply electrical energy to the storage module (3), at an operating point,
control means (5) of the generator (2) designed to adapt the operating point of said generator (2) when it supplies electrical energy to the storage module (3), according to information (530) relating to the state of the storage module (3) and information (520) relating to the state of the generator.

2. The charger (1) as claimed in claim 1, wherein the electrical generator is an electrochemical generator.

3. The charger (1) as claimed in claim 2, wherein the control means (5) of the generator (2) are designed to control a chemical reaction in the generator (2) according to information (530) relating to the state of the storage module.

4. The charger (1) as claimed in claim 2 or claim 3, wherein the electrochemical generator (2) comprises a fuel cell.

5. The charger (1) as claimed in any one of the preceding claims, wherein the connection interface of the storage module comprises a matching circuit (31) to adapt output parameters of the storage module (3) to charging parameters of the battery (41, 42).

6. The charger (1) as claimed in one of the preceding claims, wherein the information (530) relating to the state of the storage module (3) comprises its charge, its temperature, its pressure, its voltage or its intensity, at the input or output.

7. The charger as claimed in one of the preceding claims, wherein the storage module (3) comprises a plurality of storage elements (30, 301, 302, 303) and switching means (311, 312, 313, 314, 315) to connect the storage elements (30, 301, 302, 303) in parallel during charging and in series during discharging.

8. The charger (1) as claimed in one of the preceding claims, furthermore comprising means to charge the storage module (3) from an external energy source.

9. The charger (1) as claimed in claim 8, wherein the external source comprises a mains connection cable or a USB cable.

10. The charger (1) as claimed in any one of the preceding claims, wherein at least one from the electrical generator (2), the storage module (3) and the external battery (41, 42) comprises an identification device adapted to supply data to the control circuit (5), said control circuit (5) being configured to adapt its control on the basis of said data.
